(19) United States
(12) Patent Application Publication
(10) Pub. No.: US 2011/0302563 A1
(43) Pub. Date: Dec. 8, 2011

(54) PROGRAM STRUCTURE RECOVERY USING MULTIPLE LANGUAGES

(75) Inventor: Juan Jenny LI, Basking Ridge, NJ (US)

(73) Assignee: AVAYA INC., Basking Ridge, NJ (US)

(21) Appl. No.: 12/796,485

(22) Filed: Jun. 8, 2010

(51) Int. Cl. G06F 9/45

(52) U.S. Cl. 717/143; 717/144; 717/156

(57) ABSTRACT

A parser parses an application that comprises two or more different modules; the modules are bytecodes, object codes, and/or modules compiled using different programming languages. The parser identifies code statements in the modules or source code for the modules that correspond to common AST node types. A common AST node type is an abstraction of common elements in programming languages/bytecodes/object codes. Examples of code statements that are common in programming languages/bytecodes/object codes are branching, returns from functions, assignments, and the like. The use of common AST node types allows a user to generate different diagrams of the structure of the application. For example, a code flow diagram can be generated that allows a user to view the flow of code between the different modules implemented in different languages.

### TECHNICAL FIELD

The system and method relate to program analysis, testing, and quality improvement technologies based on structure recovery of code and in particular to structure recovery of code in an application developed in multiple programming languages.

### BACKGROUND

Program structure recovery takes in computer programs as inputs and) shows a graphical view of dependency among modules and control/data flow, within code modules. It provides a foundation for program analysis, which is highly useful for software understanding, testing, maintenance, and quality improvement. A well-understood program structure helps to maintain clean program design and thus better overall quality. Program structure provides testing tools and feasible points to insert probes and monitor test execution. Program structure recovery also allows static analysis tools to simulate data and control flow for defect detection.

Existing technology of program structure recovery supports only one specific language. Furthermore, it can be difficult to extend recovery to other programming languages, especially for languages that use object code or bytecodes such as Java bytecode. Sometimes, it is very important to be able to support program structure recovery from bytecode or object code when source code is not available. For example, commercial off-shelf components from a third party may only be available in bytecode or object code form. Moreover, as software applications become more and more complex, it increasingly requires the use of multiple programming languages in the same application. Therefore, besides compiled code, it is also advantageous for program recovery to support various types of programming languages easily, ranging from traditional functional program languages such as C/C++, C#, and Java, to scripting/interpretation languages such as Javascript and Perl.

### SUMMARY

The system and method are directed to solving these and other problems and disadvantages of the prior art. A parser parses an application that comprises two or more different modules; the modules are bytecodes, object codes, and/or modules compiled using different programming languages. The parser identifies code statements in the modules or source code for the modules that correspond to common Abstract Syntax Tree (AST) node types. A common AST node type is an abstraction of common elements in programming languages/bytecodes/object codes. Examples of code statements that are common in programming languages/bytecodes/object codes are branching, returns from functions, assignments, and the like. The use of common AST node types allows a user to generate different diagrams of the structure of the application. For example, a code flow diagram can be generated that allows a user to view the flow of code between the different modules.

### BRIEF DESCRIPTION OF THE DRAWINGS

These and other features and advantages of the system and method will become more apparent from considering the following description of an illustrative embodiment of the system and method together with the drawing, in which:

FIG. 1 is a block diagram of a first illustrative system for parsing multiple programming languages in an application using common AST node types.

FIG. 2 is a diagram of a Common Abstract Syntax Tree (CAST) for Java bytecode.

FIG. 3 is a diagram of a Common Abstract Syntax Tree (CAST) for “C” code.

FIG. 4 is a control flow diagram of the Java bytecode and “C” code of FIG. 2 and FIG. 3.

FIG. 5 is a flow diagram for generating different code diagrams based on common AST node types.

FIG. 6 is a flow diagram of a method for parsing multiple programming languages in an application using common AST node types.

### DETAILED DESCRIPTION

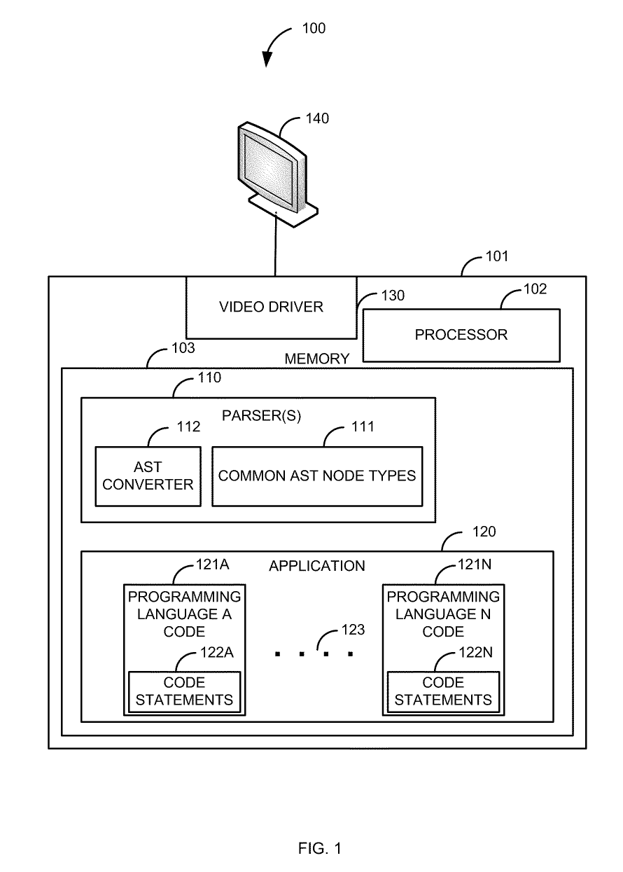

FIG. 1 is a block diagram of a first illustrative system 100 for parsing multiple languages in an application using common AST node types 111. The first illustrative system 100 comprises a computer system 101 and a display 130. The display 130 is any type of device that can display information, such as a monitor, a personal computer, a television, and the like.

The computer system 101 can be any type of computer system that can run an application 120, such as a personal computer, a server, a plurality of servers, a Private Branch eXchange (PBX), a device, an application server, a telephone, a network device, a combination of these, and the like. The computer system 101 is shown as a single device. However, the computer system 101 can be one or more devices. The computer system 101 comprises a processor 102, memory 103, and a video driver 130. The processor 102 can be any type of device that can process instructions, such as a microprocessor(s), a microcontroller(s), a multi-core processor, a computer(s), and the like.

The memory(s) 103 can be any type of memory such as Random Access Memory (RAM), Read Only Memory (ROM), flash memory, a computer disk, cache memory, a flash drive, a network disk, any combination of these, and the like. The memory as shown comprises a parser 110 and an application 120.

The parser 110 can be any type of parser that can parse the code of a programming language. When referring to code of a programming language, the intent is to include not only code that a programmer would generate, but also code that has been compiled into object code such as Java bytecode, machine code, and the like. For example, the parser 110 can be a Java code parser, a C code parser, a C++ code parser, a C# code parser, a Pascal code parser, a Fortran code parser, a Javascript parser, a Java bytecode parser, an object code parser, a machine language parser, a Perl parser, a shell script parser, and the like. The parser 110 can comprise multiple parsers. The parser 110 comprises an Abstract Syntax Tree (AST) converter 112 and common AST node types 111. The AST converter 112 takes the output of a high level language parser (i.e., a C++ parser) and converts the output of the high level language parser into Common Abstract Syntax Tree (CAST). CAST is a structure mapping of code statements 122 in different languages (i.e., a switch statement in Java or C) into common AST node types 111. This is done by mapping code statements 122 of each language into common AST node type 111 that is common to all languages.

A common AST node type 111, which represents common types of statements, is an abstraction of blocks of code that share common characteristics between different programming languages. Typical programming languages have at least five types of common AST node types 111: 1) a root node, 2) a sequence node, 3) a branch node, 4) an exit node, and 5) a composite node. A root node represents the highest level statement of a file. The root node is usually a class definition for an object oriented programming language such as Java or a list of function definitions for non-object oriented programming languages such as C. A sequence node includes expression and assignment statements. For example, x=2+i would be considered an expression. The statement i=1 would be an example of an assignment statement. A branch node includes all types of branches. Programming languages can support any or all types of branching statements, including, but not limited to: 1) two-way conditional statements, such as if-else statements and condition the part of a while-loop or for-loop, 2) multiple-way condition statements, such as switch statements in C/C++ and Java, 3) unconditional jump statements, such as a goto statement in C, and 4) function/procedure-call statements such as method or function invocation. Function/procedure-call statements are a special case. Even though the semantics of such statements might not have a branching target as in goto or condition statements, the actual execution flow does branch into the functions being called. The branching location is determined by the function names called by the original function and a look-up table maps function names to actual branch locations. An Exit node includes statements that define the exit points of a function or method. For example, return and exit statements. Even though an exit node can be considered a branching node as its execution flow moves from one method to the other, it is in a separate category because it marks the ending of a method or function in generation of control flows. A composite node represents grammars of a block of any kind of statements. An example of a composite node is grammars for headers of a function/method or class. Another composite node example is a statement list of an “if” or “else” branch. Since each function/method needs to be identified for program structure recovery, this kind of node does need an additional field to indicate whether the composite node represents a function/method body or a class or an if-else branch.

Application 120 can be any type of application such as a software application, an embedded application, a firmware application, a networked application, multiple applications, a distributed application, and the like. Application 120 is generated based on two or more types of programming language code 121 that contain code statements 122. Application 120 is shown with programming language code 121A that contains code statements 122A. Application 120 is also shown with programming language code 121N that contains code statements 122N. Application 120 can contain programming language code 121 from additional programming languages as indicated by ellipsis 123.

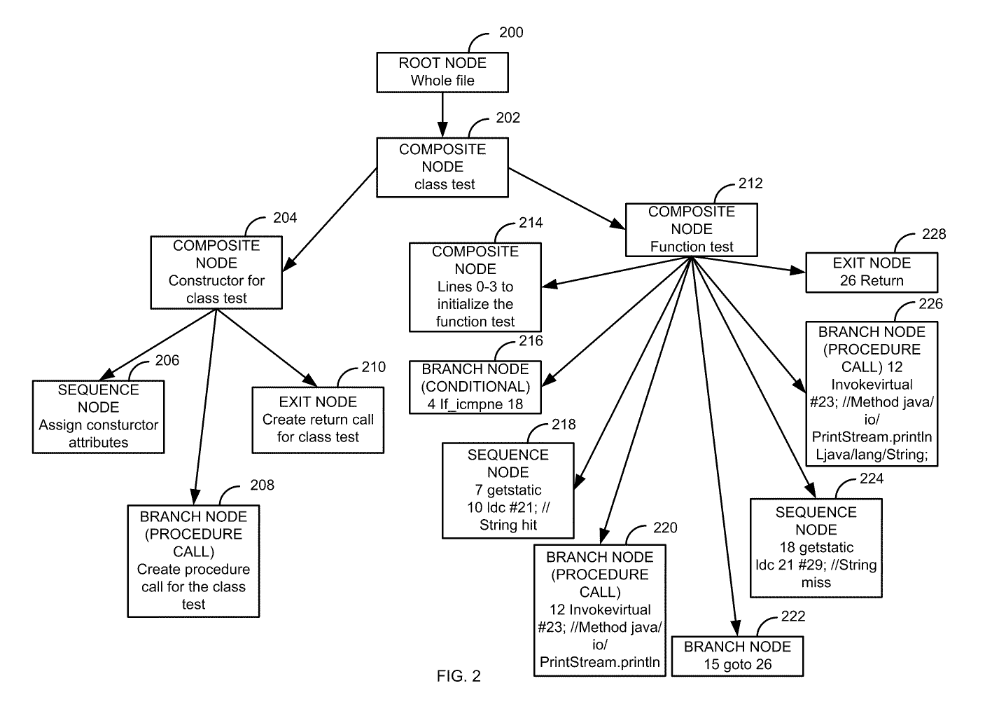

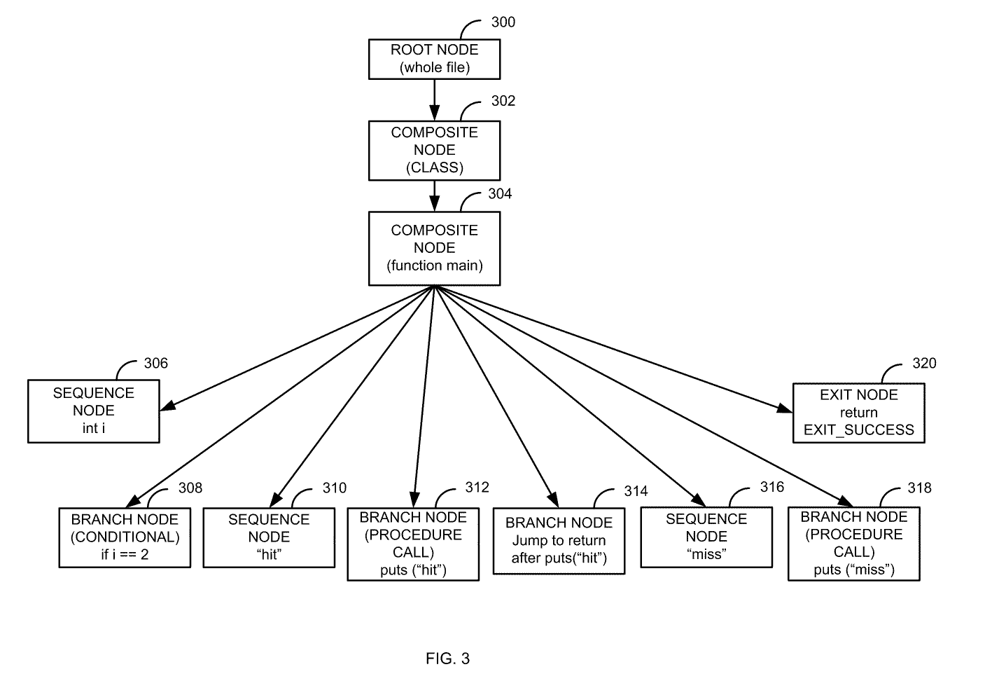

FIG. 2 is a diagram of a Common Abstract Syntax Tree (CAST) for Java bytecode. FIG. 3 is a diagram of a Common Abstract Syntax Tree (CAST) for “C” code. To illustrate the construction of CAST's for different languages, consider a program of Java bytecode shown below in Code Segment 1 and a similar program of C code shown below in Code Segment 2.

Code Segment 1

public void test(I);
Code:

| 0: | iconst_2 | |
|---|---|---|
| 1: | istore_1 | |
| 2: | iload_1 | |
| 3: | iconst_2 | |
| 4: | if_icmpne | 18 |
| 7: | getstatic | #15; //Field |
| | java/lang/System.out:Ljava/io/PrintStream; | |
| 10: | Idc | #21; //String hit |
| 12: | invokevirtual | #23; //Method |
| | java/io/PrintStream.println:(Ljava/lang/String;)V | |
| 15: | goto | 26 |
| 18: | getstatic | #15; //Field |
| | java/lang/System.out:Ljava/io/PrintStream; | |
| 21: | Idc | #29; //String miss |
| 23: | invokevirtual | #23; //Method |

| | |
|---|---|
| | java/io/PrintStream.println:(Ljava/lang/String;)V |
| 26: | return |

```
int main(int i) {
  if (i == 2) puts(“hit”);
  else puts(“miss”);
  return EXIT_SUCCESS;
}
```

The two programs have a similar functional effect, i.e., both check the value of input “i”. If the value of “i” is 2, then it is a hit, otherwise it is a miss. However, the two languages have very different grammar rules. In fact, the Java bytecode in Code Segment 1 includes mostly memory/variable loading and conditional or unconditional branching statements. Using the five common AST node type definitions, the CAST's described previously in the above two programs in Code Segment 1 and Code Segment 2 will have the same types of nodes, including root nodes, sequence nodes, branch nodes, exit nodes, and composite nodes.

FIG. 2 represents a CAST of the common AST node types (200-228) and their equivalent Java bytecode code statements 122. Each common AST node type (200-228) in FIG. 2 represents a specific portion of the Java bytecode or file. Root Node 200 is the root node which represents the file for the Java bytecode represented in Code Segment 1. Composite node 202 represents the class test. Composite node 204 represents constructor code for a class that is generated in object oriented programming languages such as Java and C++. If a constructor has not been defined by a developer, the compiler will automatically generate a constructor for a class. Composite node 204 represents the constructor that is generated by the compiler. When a constructor is created by the compiler, the compiler assigns constructor attributes, creates a procedure call for the constructor, and creates a return from the constructor. Sequence node 206 represents the assigned constructor attributes for the class test. Branch node 208 represents the procedure call for the class test. Exit node 210 represents the return call for the class test.

Composite node 212 represents the function test in class test. All nodes below composite node 212 represent the various common AST node types (214-228) in the function test. Composite node 214 represents lines 0-3 of Code Segment 1. Even though composite node 214 represents four lines of bytecode, it is shown as a single composite node. However, composite node 214 could be shown as four separate composite nodes. Branch node 216 represents the if compare not equal on line 4 (if_compne, branch to line 18 if not equal). Sequence node 218 represents the getstatic on line 7 which loads Ljava/io/PrintStream onto the stack and the load constant on stack (Idc) on line 10 of the string “hit.” Note that sequence node 218 represents two assignment statements and can be represented by two sequence nodes. Branch node 220 represents the procedure call on line 12 (invokevirtual) to the Java method java/io/PrintStream.println to print the string “hit.” Branch node 222 represents the goto 26 statement on line 15. Sequence node 224 represents the getstatic on line 18 which loads Ljava/io/PrintStream onto the stack and the load constant on stack (ldc) on line 21 of the string “miss.” Branch node 226 represents the procedure call on line 23 (invokevirtual) to the Java method java/io/PrintStream.println to print the string “miss.” Exit node 228 represents the return on line 26.

FIG. 3 represents a CAST of the common AST node types (300-320) and their equivalent C code statements 122. Each common AST node type (300-320) in FIG. 3 represents a specific portion of the C code or file. Root Node 300 is the root node which represents the file (which contains the function main) for the C code represented in Code Segment 2. Composite node 302 represents the class. In this example, C is not an object oriented programming language so composite node 302 is a place holder to maintain consistency between programming languages. Composite node 304 represents the function main.

Sequence node 306 represents the int i that is passed to the function main. Branch node 308 represents the conditional statement if(i==2). Sequence node 310 represents the assignment of the string hit. Branch node 312 represents the procedure call to the method and puts in which the string hit is passed. Branch node 314 is the jump to the return EXIT_SUCCESS that occurs after the puts (“hit”). Sequence node 316 represents the assignment of the string miss. Branch node 318 represents the procedure call to the method puts in which string miss is passed. Exit node 320 represents the return with the integer EXIT_SUCCESS.

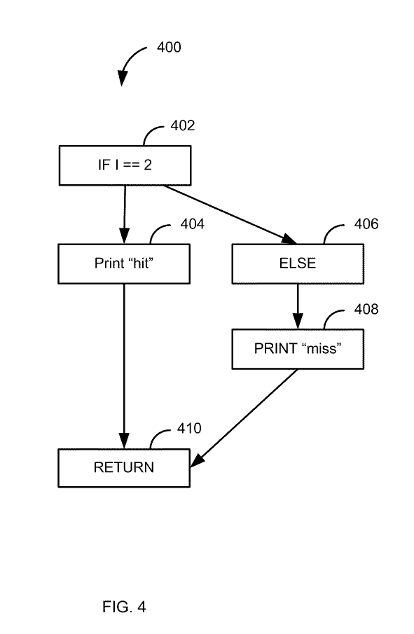

FIG. 4 is an exemplary control flow diagram 400 of the Java bytecode and “C” code of FIG. 2 and FIG. 3. A control flow diagram is a diagram showing the flow of the code within application 120 and/or within a specific function. The example in FIG. 4 is the code flow within the class test or the code flow within the function main. The exemplary control flow diagram is the same for both FIG. 2 and FIG. 3 because both programs do basically the same thing. The process of FIG. 2 and FIG. 3 determines in step 402 if i==2. If i==2 in step 402, the word “hit” is printed in step 404 and the process returns in step 410. Otherwise, the process flows to the else statement in step 406. The word “miss” is printed in step 408 and the process goes to the return in step 410.

A flow control diagram can also show the flows between function/class calls. Since common AST node types 111 are being used to define the flow of code in a function/class, common AST node types 111 can now be used to define the flow of code between functions/classes. This includes the flow of code between functions in different programming languages. For example, if application 120 has Java code that calls Java Native Interface (JNI) code (JNI allows a function call to code written in a different programming language). The flow of the code from the Java code to the C code can now be shown in detail to allow a developer to see the full structure of application 120 in the different programming languages 121A-121N.

A flow control diagram can show the common AST node types 111 and the flow of code between the common AST node types 111. The flow control diagram can show the flow of code between functions/classes or show different portions of the code within application 120. Depending upon the developer's needs, the flow control diagram can show different combinations of the above. With a common structure, it is easy to show the flow between the different programming languages 121A-121N within application 120.

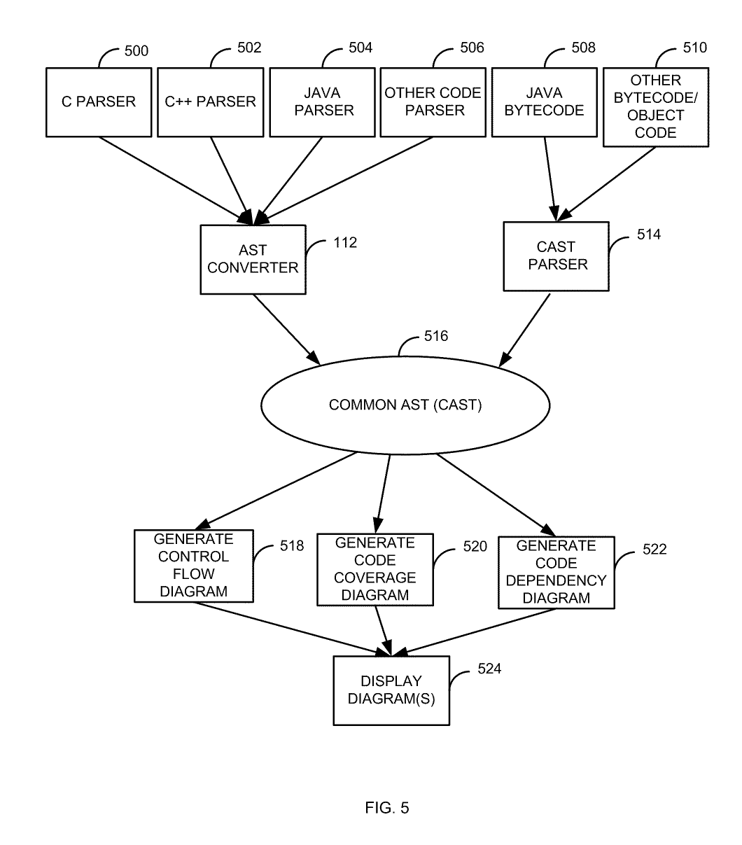

FIG. 5 is a flow diagram for generating different code diagrams based on common AST node types 111. Standard native language parsers such as C parser 500, C++ parser 502, Java parser 504, and other code parsers 506 can generate an Abstract Syntax Tree (AST) for the specific programming language being used. The output from the parsers 500-506 can then be converted into CASTs 516 using AST converter 112. This is done by the AST converter 112 looking at common AST node types 111 to determine a mapping from a code statement 122 in the specific language to a common AST node type 111. The common AST node types 111 that are generated from the different programming languages (e.g., common AST node types 300-320) are then used to generate CAST 516. The Java bytecode 508 and other bytecode/object code 510 are input into CAST parser 514. CAST parser 514 can then generate CAST 516 by looking at the common AST node types 111 to determine a mapping from the bytecodes/object codes to the common AST node types 111 to produce CAST 516.

The CAST 516 from the various languages (e.g., Java bytecode, C, C++) can then be processed in various ways to help developers to manage application 120. Since the system has a common way of viewing the code structure of the different programming languages, the system can provide a more robust view of the application 120. A control flow diagram can be generated 518 and displayed to a user. Other types of diagrams can be displayed to a user. Other types of diagrams can be generated and displayed 524 to a user. For example, a code coverage diagram 520 can be generated. A code coverage diagram shows which sections (i.e., specific code statements) of the code have been hit by a testing program and which sections of the code have not been hit. This allows the developer to determine better tests to hit the sections of code that have not been hit previously. Another type of diagram that can be generated is a code dependency diagram 522. A code dependency diagram 522 is a diagram that shows the structure of class dependency. For example if class B depends from class A, the code dependency diagram 522 can show the dependency and which functions are inherited from class A.

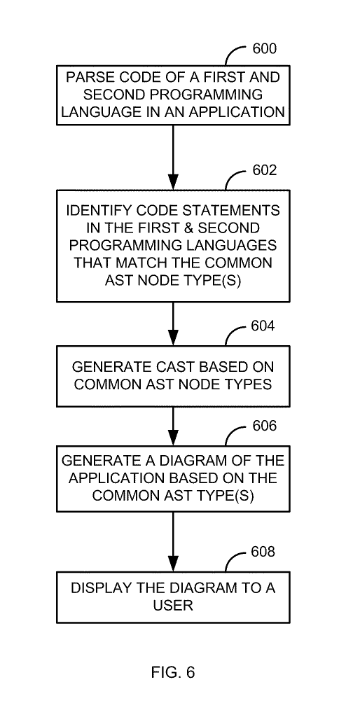

FIG. 6 is a flow diagram of a method for parsing multiple programming languages in an application using common AST node types 111. Illustratively, the parser 110, the AST converter 112, the common AST node types 111, and application 120 are stored-program-controlled entities, such as a computer or processor, which performs the method of FIG. 6 and the processes described herein by executing program instructions stored in a computer readable storage medium, such as a memory or disk.

The parser 110 parses 600 code of first programming language 121A and code of a second programming language 121N. The parser 110 identifies in step 602 code statements 122A for the first programming language 121A that match the common AST node types 111 for the first programming language 121A. The parser 110 identifies in step 602 code statements 122N for the second programming language 121N that match the common AST node types 111 for the second programming language 121N. For example, if the first programming language is “C” and the line of code states “goto END_OF_FILE;”, the parser 110 will look in the common AST node types 111 for the “C” language to identify that the goto statement is an unconditional branch node common AST node type that branches to where the identifier END_OF_FILE points. The process in step 602 can be done by the parser 110 going through each file/function/class in application 120 to identify each of the code statements 122A-122N and then match the common AST node type 111 to generate the CAST 516 for application 120.

The parser 110 generates 604 CAST 516 based on matching common AST node types 111 for the first programming language and the second programming language. From CAST 516, the structure and flow of application 120 can then be determined based on the common AST node types in CAST 516. Video driver 130 can then generate 606 a diagram (e.g., control flow diagram 518) of application 120 based on the common AST node types for display 608 in display 140 to a user.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. For example, some programming languages have built-in exception handling that would be treated as a Common AST branch node type. These changes and modifications can be made without departing from the spirit and the scope of the system and method and without diminishing its attendant advantages. The above description and associated Figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method implemented by a processor comprising:
a. parsing code of a first programming language and a second programming language in an application;
b. identifying a code statement in both the first programming language and the second programming language, wherein the code statement for the first programming language and the code statement for the second programming language matches a common AST node type;
c. generating a Common Abstract Syntax Tree (CAST) for both the first programming language and the second programming language based on matching the common AST node type; and
d. generating a diagram of at least part of the application based on the CAST for both the first programming language and the second programming language.

2. The method of claim 1, wherein the diagram is a control flow diagram and further comprising the steps of displaying the control flow diagram based on the CAST for both the first programming language and the second programming language.

3. The method of claim 1, wherein the diagram is at least one of the following: a control flow diagram, a code dependency diagram, and a code coverage diagram.

4. The method of claim 1, wherein the common AST node type comprises the following: a root node, a sequence node, a branch node, an exit node, and a composite node.

5. The method of claim 1, further comprising the step displaying the diagram to a user.

6. The method of claim 1, wherein the first and second programming languages comprise at least one of the following: Java source code, Java bytecode, C, C++, C#, Javascript, Perl, Pascal, and Fortran.

7. The method of claim 1, wherein the first programming language is high level programming language and the second programming language is a bytecode or object code language, wherein parsing the first programming language is done by a native parser and parsing the second programming language is done by a Common AST parser, and wherein generating the CAST for the first programming language comprises converting the output of the native parser into the CAST for the first programming language.

8. The method of claim 1, wherein the first programming language is an object oriented programming language and at least part of the CAST is generated based on a constructor.

9. A computer readable medium having stored thereon instructions that cause a processor to execute a method, the method comprising:
a. instructions to parse code of a first programming language and a second programming language in an application;
b. instructions to identify a code statement in both the first programming language and the second programming language, wherein the code statement for the first programming language and the code statement for the second programming language matches a common AST node type;
c. instructions to generate a Common Abstract Syntax Tree (CAST) for both the first programming language and the second programming language based on matching the common AST node type; and
d. instructions to generate a diagram of at least part of the application based on the CAST for both the first programming language and the second programming language.

10. The method of claim 1, wherein the diagram is a control flow diagram and further comprising instructions to display the control flow diagram based on the CAST for both the first programming language and the second programming language.

11. The method of claim 1, wherein the diagram is at least one of the following: a control flow diagram, code dependency diagram, and a code coverage diagram.

12. The method of claim 1, wherein the common AST node type comprises the following: a root node, a sequence node, a branch node, an exit node, and a composite node.

13. The method of claim 1, further comprising instructions to display the diagram to a user.

14. The method of claim 1, wherein the first and second programming languages comprise at least one of the following: Java source code, Java bytecode, C, C++, C#, Javascript, Perl, Pascal, and Fortran.

15. The method of claim 1, wherein the first programming language is high level programming language and the second programming language is a bytecode or object code language, wherein parsing the first programming language is done by a native parser and parsing the second programming language is done by a Common AST parser, and wherein generating the CAST for the first programming language comprises converting the output of the native parser into the CAST for the first programming language.

16. The method of claim 1, wherein the first programming language is an object oriented programming language and at least part of the CAST is generated based on a constructor.

17. A computer system comprising:
a. a parser configured to parse code of a first programming language and a second programming language in an application, identify a code statement in both the first programming language and the second programming language, wherein the code statement for the first programming language and the code statement for the second programming language matches a common AST node type, generate a common AST node type for both the first programming language and the second programming based on matching the common AST node type; and
b. a video driver configured to generate a Common Abstract Syntax Tree (CAST) for both the first programming language and the second programming language based on matching the common AST node type and generate a diagram of at least part of the application based on the CAST for both the first programming language and the second programming language.
